(19) United States
(12) Patent Application Publication
(10) Pub. No.: US 2011/0292465 A1
(43) Pub. Date: Dec. 1, 2011

(54) IMAGE READING APPARATUS

(76) Inventors: NAMIE SUGIYAMA, Shizuoka (JP); Koushi Takano, Tokyo (JP); Keisuke Hatomi, Tokyo (JP); Hiroyuki Okada, Tokyo (JP)

(21) Appl. No.: 13/103,897

(22) Filed: May 9, 2011

(30) Foreign Application Priority Data
May 25, 2010 (JP) 119671/2010

(51) Int. Cl. H04N 1/04

(52) U.S. Cl. 358/474

(57) ABSTRACT

An image reading apparatus includes image reader reading an image of a manuscript which is placed on a manuscript platen, and size detector detecting a size of the manuscript, wherein the image reader slides inside a chassis, which is arranged below the manuscript platen, in parallel to the manuscript platen and reads the image of the manuscript, wherein the size detector includes two light sensors each of which is composed of a pair of light emitter emitting light toward the manuscript platen from a position under the manuscript platen, and light receiver receiving reflection light which is reflected by the manuscript, wherein the light emitter and the light receiver are mounted on one substrate so that each line connecting the light emitter with the light receiver of the light sensor may be on one straight line, and wherein the size detector is arranged at one internal side area of the chassis, which does not overlap with an area through which the image reader slides, so that the line connecting the light emitter with the light receiver may be parallel to a sliding direction of the image reader.

### INCORPORATION BY REFERENCE

This application is based upon and claims the benefit of priority from Japanese Patent Application No. JP 2010-119671, filed on May 25, 2010, the disclosure of which is incorporated herein in its entirety by reference.

### BACKGROUND OF THE INVENTION

1. Technical Field

The present invention relates to an image reading apparatus to read an image of a manuscript and particularly, relates to an image reading apparatus equipped with a size sensor to detect a size of a manuscript which is placed on a manuscript platen for example.

2. Background Art

There are many well-known image reading apparatuses each of which detects a size of a manuscript placed on a manuscript platen and reads an image of the manuscript.

First, a general image reading apparatus will be described. FIG. 9 is an explanatory diagram showing an example of the general image reading apparatus. Moreover, FIG. 10 is an explanatory diagram showing a state in which a manuscript 2 is placed on the general image reading apparatus exemplified in FIG. 9. The image reading apparatus exemplified in FIG. 9 includes an optical module 1 and a size sensor 3 inside a chassis 11. The optical module 1 slides in a sub scanning direction which is indicated by an arrow S in FIG. 9 to read an image of the manuscript 2. The size sensor 3 is mounted on a base plane 12 of the chassis and judges the size (length) of the manuscript 2.

FIG. 11 is an explanatory diagram showing a state in which the size sensor 3 is mounted on the general image reading apparatus exemplified in FIG. 9. The size sensor 3 includes a light emitting unit 5, a light receiving unit 6 and a connecting unit 8. The light emitting unit 5, the light receiving unit 6 and the connecting unit 8 are mounted on a substrate 7. Moreover, a cable holding unit 24 is arranged between the optical module 1 and the size sensor 3.

Here, a method how the size sensor 3 judges the size of the manuscript 2 will be described. FIG. 12 is an explanatory diagram showing an operation of the size sensor 3. In the case that the manuscript 2 is placed over the size sensor 3, emission light 9, which is emitted by the light emitting unit 5, irradiates the manuscript 2 and then, the reflection light 10, which is reflected by the manuscript 2, is received by the light receiving unit 6. The size sensor 3 judges that the manuscript 2 exists at the position by receiving the reflection light 10. On the other hand, in the case that there is no manuscript 2 over the size sensor 3, the emission light 9 which is outputted from the light emitting unit 5 is not reflected by the manuscript 2. Since the light receiving unit 6 does not receive any reflection light 10, the size sensor 3 judges that the manuscript 2 does not exist at the position.

FIG. 10 shows a state in which two size sensors 3 mentioned above are arranged side by side. As mentioned above, each size sensor 3 judges whether the manuscript 2 exists over the size sensor 3. Then, the image reading apparatus judges finally the size (length) of the manuscript 2 on the basis of a combination of judgments by the size sensors 3.

Next, a method how the optical module 1 carries out a scanning for reading the image will be described. FIG. 13 is an explanatory diagram which shows an internal state of the general image reading apparatus exemplified in FIG. 9. As shown in FIG. 13, a wire 16, a rail 17, a drum 18, a motor 19 and a lamp 20 in addition to the optical module 1 are included inside the chassis 11 of the image reading apparatus. The lamp 20 is mounted on the optical module 1, and light which is emitted from the lamp 20 irradiates the manuscript 2 in order to read an image of the manuscript 2.

The optical module 1 is placed on the rail 17 which is arranged inside the chassis 11. The wires 16 are connected to both ends of the optical module 1. Each wire 16 is wound around the drum 18. The dram 18 rotates through being driven by the motor 19. According to the structure, the wire 16 is wound through the motor 19 driving the dram 18 to rotate the drum 18. In this way, the optical module 1 is drawn toward the drum 18. At this time, the drawn optical module 1 slides in parallel to the manuscript 2 to carry out the scanning for reading the manuscript 2.

Next, structure of the optical module 1 will be described. FIG. 14 is an explanatory diagram which shows a cross section view taken along A-A line of the general image reading apparatus exemplified in FIG. 9. The optical module 1 includes CCD (Charge Coupled Device) 21, a mirror 22 and a lens 23. Further, the optical module 1 slides in the sub scanning direction which is indicated by the arrow S. When the light, which is emitted by the lamp 20, irradiates the manuscript 2, light which is reflected by the manuscript 2 is reflected repeatedly by several mirrors 22. Afterward, the reflection light is concentrated by the lens 23. When the concentrated light comes in a pixel plane of CCD 21, CCD 21 converts the electric charge to an electric signal. In this way, the optical module 1 reads the image of the manuscript 2.

Meanwhile, patent document 1 (Japanese Patent Application Laid-Open No. 1995-23182) discloses a manuscript reading apparatus which judges a size of a manuscript placed on a manuscript platen. According to the manuscript reading apparatus which is disclosed in the patent document 1, a manuscript detecting sensor is arranged at a position where is on a base plane of the manuscript reading apparatus with no interference in an optical unit's sliding. The manuscript detecting sensor optically detects the manuscript which is placed on the manuscript platen.

The general image reading apparatus, which is shown in FIG. 9, mounts two size sensors 3 separately, as shown in FIG. 11. Therefore, it is necessary to prepare a space for mounting the size sensor 3 in a central area of the chassis 11. As a result, a problem that an external form of the apparatus in a direction of the apparatus plane becomes large is caused. According to the general image reading apparatus, the size sensor 3 is mounted just under a place where the optical module 1 passes. Therefore, it is necessary for the base plane 12 of the chassis to be in a form which is projecting from the chassis in a downward direction so that the size sensor 3 may not touch the optical module 1. Specifically, it is necessary to arrange a size sensor fixing member 13 inside the chassis 11 and on the base plane 12 of the chassis, as shown in FIG. 14. Therefore, a problem that the chassis 11 becomes high by a height of the size sensor fixing component 13 is caused.

### SUMMARY

An object of the present invention is to provide an image reading apparatus which includes a size sensor for detecting a size of a manuscript, and whose external form can be made miniaturized.

An image reading apparatus includes image reader reading an image of a manuscript which is placed on a manuscript platen, and size detector detecting a size of the manuscript, wherein the image reader slides inside a chassis, which is arranged below the manuscript platen, in parallel to the manuscript platen and reads the image of the manuscript, wherein the size detector includes two light sensors each of which is composed of a pair of light emitter emitting light toward the manuscript platen from a position under the manuscript platen, and light receiver receiving reflection light which is reflected by the manuscript, wherein the light emitter and the light receiver are mounted on one substrate so that each line connecting the light emitter with the light receiver of the light sensor may be on one straight line, and wherein the size detector is arranged at one internal side area of the chassis, which does not overlap with an area through which the image reader slides, so that the line connecting the light emitter with the light receiver may be parallel to a sliding direction of the image reader.

### BRIEF DESCRIPTION OF THE DRAWINGS

Exemplary features and advantages of the present invention will become apparent from the following detailed description when taken with the accompanying drawings in which:

FIG. 1 is an explanatory diagram showing an exemplary embodiment of an image reading apparatus according to the present invention;

FIG. 2 is an explanatory diagram showing an example of a size sensor 4 according to the exemplary embodiment;

FIG. 3 is an explanatory diagram showing an example of the size sensor 4 which is fixed by a sensor holding unit 14;

FIG. 4 is an explanatory diagram showing a cross section view taken along C-C line of the image reading apparatus shown in FIG. 1;

FIG. 5 is an explanatory diagram showing a perspective view of a cross section taken along B-B line of the image reading apparatus shown in FIG. 1;

FIG. 6 is an explanatory diagram showing a cross section view taken along B-B line of the image reading apparatus shown in FIG. 1;

FIG. 7 is an explanatory diagram showing a cross section view taken along D-D line of the image reading apparatus shown in FIG. 1;

FIG. 8 is an explanatory diagram showing an example of the minimum structure of the image reading apparatus according to the present invention;

FIG. 9 is an explanatory diagram showing an example of a general image reading apparatus;

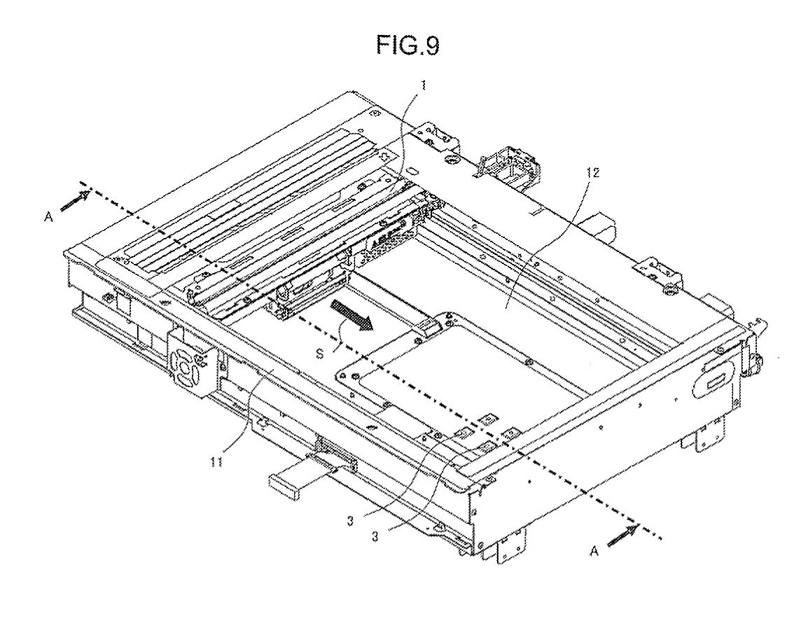

FIG. 10 is an explanatory diagram showing a state in which a manuscript is placed on the general image reading apparatus;

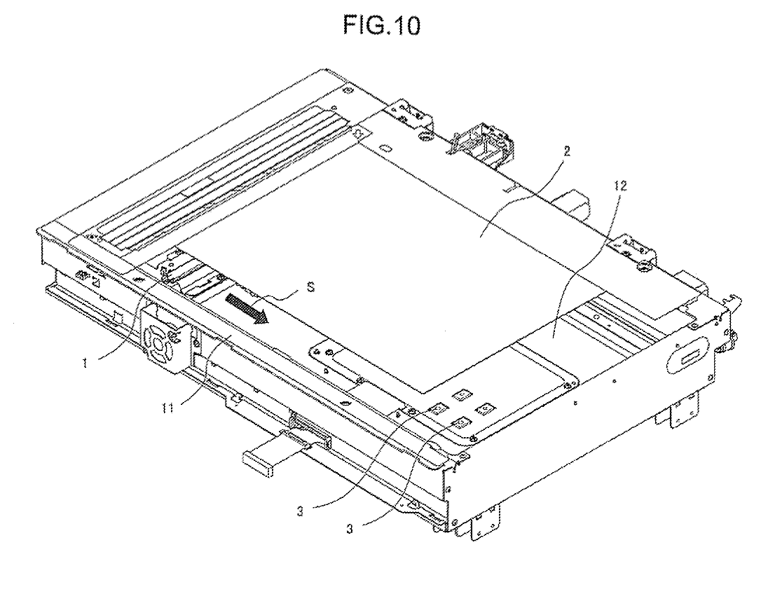

FIG. 11 is an explanatory diagram showing a state in which a size sensor is mounted on the general image reading apparatus;

FIG. 12 is an explanatory diagram showing an operation of the size sensor which is mounted on the general image reading apparatus;

FIG. 13 is an explanatory diagram showing an internal state of the general image reading apparatus; and

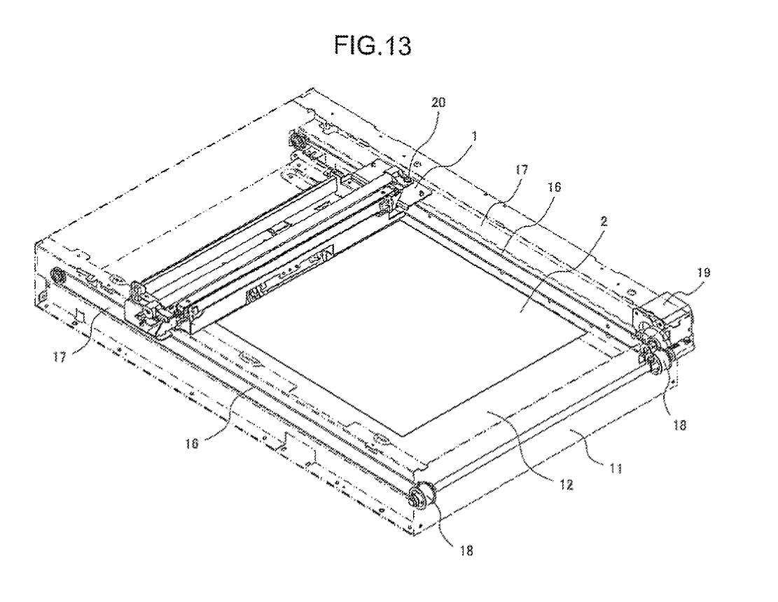

FIG. 14 is an explanatory diagram showing a cross section view taken along A-A line of the image reading apparatus shown in FIG. 9.

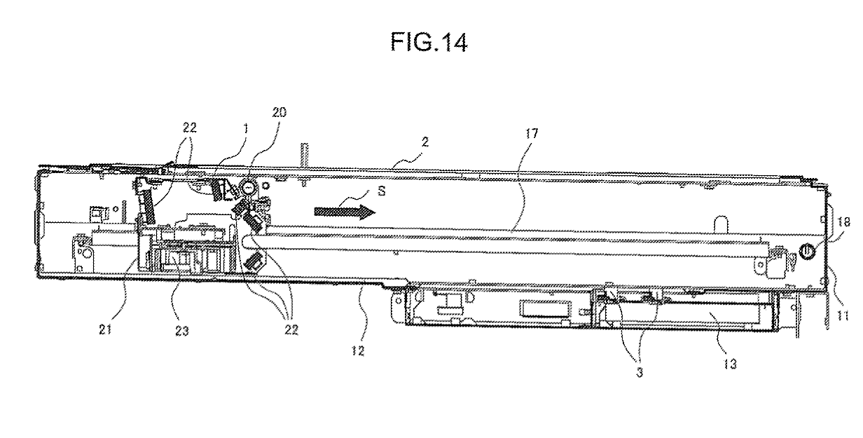

### EXEMPLARY EMBODIMENT

Exemplary embodiments of the present invention will now be described in detail in accordance with the accompanying drawings.

### A First Exemplary Embodiment

Hereinafter, an exemplary embodiment of the present invention will be described with reference to a drawing.

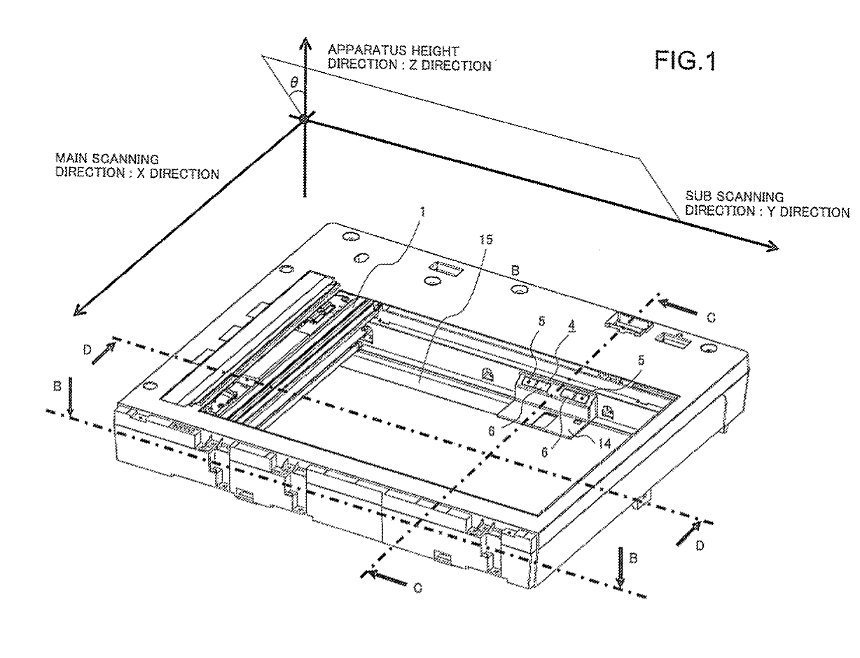

FIG. 1 is an explanatory diagram showing an exemplary embodiment of an image reading apparatus according to the present invention. Further, a main scanning direction, a sub scanning direction and a height direction of the image reading apparatus are denoted as a X direction, a Y direction and a Z direction respectively in the following description. The image reading apparatus according to the exemplary embodiment includes the optical module 1 and a size sensor 4.

The optical module 1 slides in the sub scanning direction (Y direction) and reads an image of a manuscript.

The size sensor 4 detects a length of the manuscript in a sliding direction of the optical module 1 (that is, sub scanning direction). It may be preferable that the size sensor 4 detects the size of the manuscript, for example, at any timing before a manuscript cover of the image reading apparatus is closed on the manuscript.

While a fax machine and a copying machine are exemplified as a specific image reading apparatus, the image reading apparatus is not limited to these apparatuses. The size sensor 4 is fixed to one end (one side end) of the chassis 11 in an oblique state by a sensor holding unit 14.

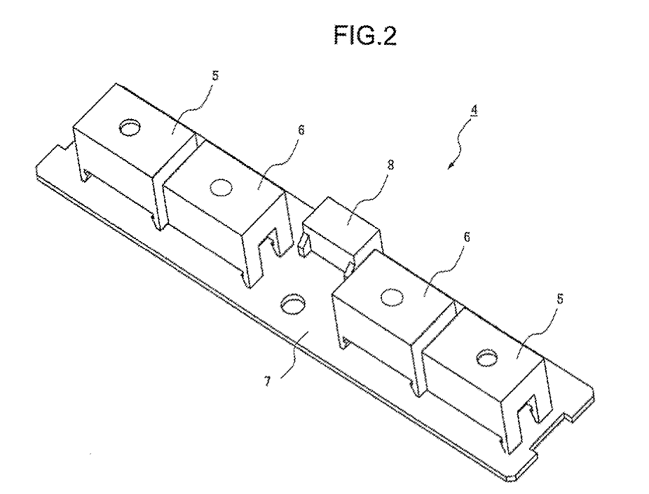

FIG. 2 is an explanatory diagram showing an example of the size sensor 4 according to the exemplary embodiment. The size sensor 4 includes two light emitting units 5, two light receiving units 6 and the connecting unit 8. The light emitting unit 5 and the light receiving unit 6, which compose a pair, detect whether the manuscript is placed on a manuscript platen. The connecting unit 8 connects the light emitting unit 5 and the light receiving unit 6 each other to transmit a signal.

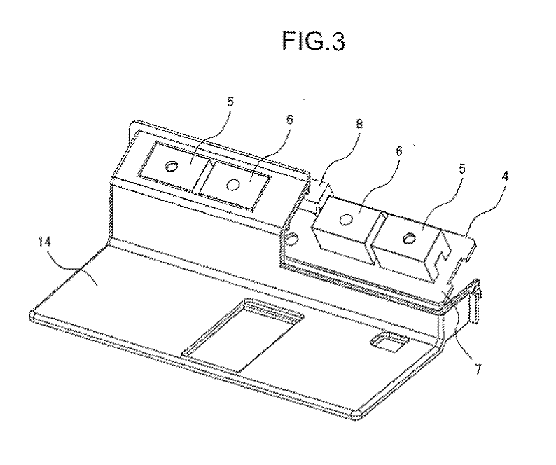

FIG. 3 is an explanatory diagram showing a state in which the size sensor 4 is fixed obliquely by the sensor holding unit 14. The sensor holding unit 14 is formed so as not to disturb that the light emitting unit 5 emits light and the light receiving unit 6 receives light. Moreover, the sensor holding unit 14 is formed so that the light emitting unit 5 and the light receiving unit 6 may be open upward.

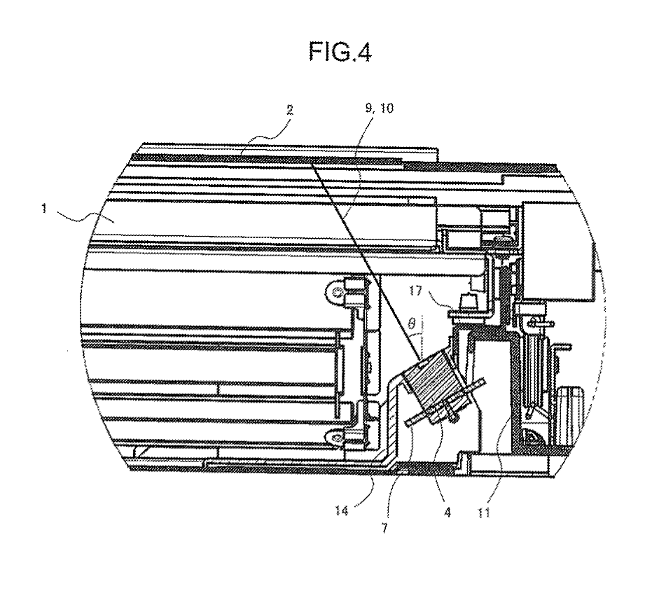

The size sensor 4 is arranged obliquely so that an axis of the light, which is emitted by the light emitting unit 5, is on a plane which is at a right angle to a plane X-Z and which is at an angle θ (specifically, shown in FIG. 4) to a plane Y-Z, as shown in FIG. 1. Moreover, the size sensor 4 is arranged under a side, against which the manuscript is hit, within the chassis 11. Here, the angle θ has any value which is determined so that the axis of the light, which the size sensor 4 (more specifically, light emitting unit 5) emits, may come in an inside of an opening made of glass. Moreover, the size sensor 4 is arranged so that a line connecting the light emitting unit 5 with the light receiving unit 6 may be in parallel to the sub scanning direction.

FIG. 4 is an explanatory diagram showing a cross section view taken along C-C line of the image reading apparatus shown in FIG. 1. An example in FIG. 4 shows that the size sensor 4 is placed obliquely for a X-Y plane. As mentioned above, the size sensor 4 is arranged obliquely so that the axis of the light, which is emitted by the light emitting unit 5, may be at the angle θ with the vertical direction. Therefore, it is possible to judge whether the manuscript is placed on the manuscript platen, even if the size sensor 4 is not arranged on the base plane of the chassis 11.

The light emitting unit 5 emits light (emission light) toward the manuscript platen. Moreover, the light receiving unit 6 receives light (reflection light) which is reflected by the manuscript 2. Specifically, since the emission light which the light emitting unit 5 emits is reflected diffusely by the manuscript 2, the light receiving unit 6 receives the reflection light which is reflected diffusely by the manuscript 2. In the case that the light emitting unit 5 emits the emission light, and the light receiving unit 6 receives the reflection light which is reflected by the manuscript 2 after the emission light irradiates the manuscript 2, the size sensor 4 judges that there exists the manuscript. On the other hand, in the case that the light receiving unit 6 does not receive any reflection light, the size sensor 4 judges that the manuscript does not exist.

Each pair of the light emitting unit 5 and the light receiving unit 6 is arranged adjacently to another pair on the substrate 7. Moreover, the light emitting unit 5 and the light receiving unit 6 are mounted on the substrate 7 so that each line connecting the light emitting unit 5 with the light receiving unit 6 which belong to the pair may be on one straight line. Furthermore, the connecting unit 8 is mounted on the substrate 7 in parallel with the light emitting unit 5 and the light receiving unit 6. In this case, each of the light emitting unit 5 and the light receiving unit 6 are arranged so that one light receiving unit 6 out of two light receiving units 6 (that is, adjacent two light receiving units 6) may receive light whose direction is opposite to a direction of light received by the other light receiving unit 6. As a result, the emission light from the light emitting unit 5 cannot come in the adjacent light receiving unit 6 (that is, light receiving unit which does not compose the pair).

Specifically, out of two pairs each of which is composed of the light emitting unit 5 and the light receiving unit 6, the light emitting unit 5 and the light receiving unit 6, which belong to one pair near to a manuscript reading starting position, are arranged in such an order that the light emitting unit 5 is nearer to the manuscript reading starting position than the light receiving unit 6. On the other hand, the light emitting unit 5 and the light receiving unit 5, which belong to the other pair, are arranged in such an order that the light receiving unit 6 is nearer to the manuscript reading starting position than the light emitting unit 5. In other word, the arrangement order of the light emitting unit 5 and the light receiving 6 unit which belong to one pair is reverse to the arrangement order of the light emitting unit 5 and the light receiving unit 6 which belong to the other pair. That is, concerning the arrangement of the light emitting units 5 and the light receiving units 6, one light emitting unit 5 out of two light emitting units 5 is arranged nearest to the manuscript reading starting position, and the other light emitting unit 5 is arranged farthest from the manuscript reading starting position.

As mentioned above, the size sensor 4 has two pairs each of which is composed of the light emitting unit 5 and the light receiving unit 6. Moreover, the light emitting unit 5 and the light receiving unit 6 are mounted on one substrate 7 so that each line connecting the light emitting unit 5 with the light receiving unit 6 may be on one straight line. Since all of the light emitting units 5 and the light receiving units 6 are arranged on the straight line as mentioned above, it is possible to handle the size sensor 4 as one component.

The size sensor 4 and the sensor holding unit 14 are arranged by use of a space, where the optical module 1 does not pass, in order not to touch the optical module 1 even if the optical module 1 passes. As exemplified in FIG. 4, the size sensor 4 is arranged, for example, between the rails 17 which are arranged at both ends of the main scanning direction within the chassis 11 in order to draw the optical module 1. Since the size sensor 4 is arranged between the rails 17 as mentioned above, it is possible to make depth of the chassis small. As a result, it is possible to make the apparatus miniaturized.

Since the optical module 1 reads the manuscript from a position below the manuscript platen, an area of the manuscript platen (opening) for reading the manuscript is generally made of glass. Then, the size sensor 4 is arranged at a position within the chassis 11 which does not overlap with an area to which the glass opening area of the manuscript platen is projected vertically. By arranging the size sensor 4 at the position mentioned above, it is possible to reduce external light, which is emitted from a position over the manuscript reading apparatus, such as light from a fluorescent lamp. As a result, it is possible to reduce an incorrect judgment on the size of the manuscript.

Moreover, it may be preferable that the size sensor 4 is arranged at the position which does not overlap with the area to which the glass opening area is projected vertically and which is between the rails 17 (more specifically, space which is formed by tracks of the optical module 1 and the rail 17). As a result, it is possible to raise the base plane of the chassis 11 up to a bottom level of the optical module 1. As a result, it is possible to prevent the apparatus from being high and it is also possible to make the base plane of the chassis 11 almost flat.

It is also possible to fix FFC15, which is connected to the optical module 1, on the base plane of the chassis 11 by use of the sensor holding unit 14. Through fixing FFC15 by use of the sensor holding unit 14, it is possible to reduce number of components which are used in the image reading apparatus.

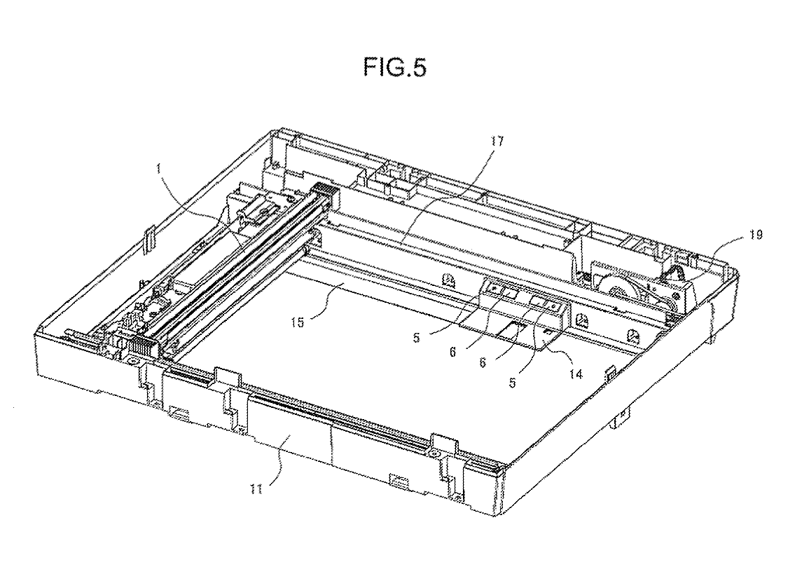

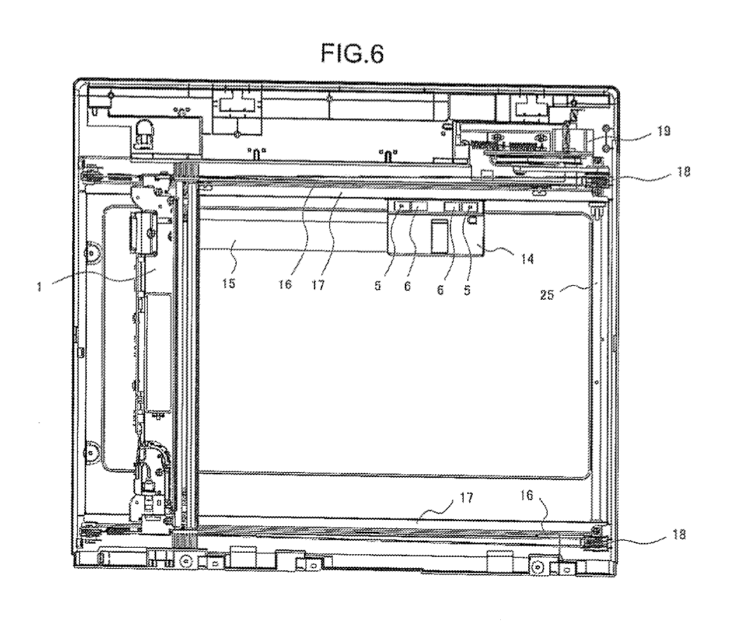

Next, an operation will be described. FIG. 5 is an explanatory diagram showing a perspective view of a cross section taken along B-B line of the image reading apparatus shown in FIG. 1. FIG. 6 is an explanatory diagram showing a cross section view taken along B-B line of the image reading apparatus shown in FIG. 1.

The image reading apparatus shown in FIG. 5 or FIG. 6 includes the wire 16, the rail 17, the drum 18 and the motor 19 within the chassis 11.

The optical module 1 is placed on the rail 17 which is arranged within the chassis 11. The wires 16 are connected to both ends of the main scanning direction of the optical module 1 respectively. The drum 18 is arranged in a direction which is at a right angle with the main scanning direction (sub scanning direction). Each of the wires 16 is wound around the drum 18. One of drums 18 is connected to the motor 19. By the motor 19 driving the drum 18, each of two drums 18 winds each of the wires 16 via a drum shaft 25 which connects the drums 18 each other. By winding the wire 16, the optical module 1 is drawn along the rail 17. As a result, the optical module 1 slides in parallel to the manuscript 2 to carry out the scanning for reading the image.

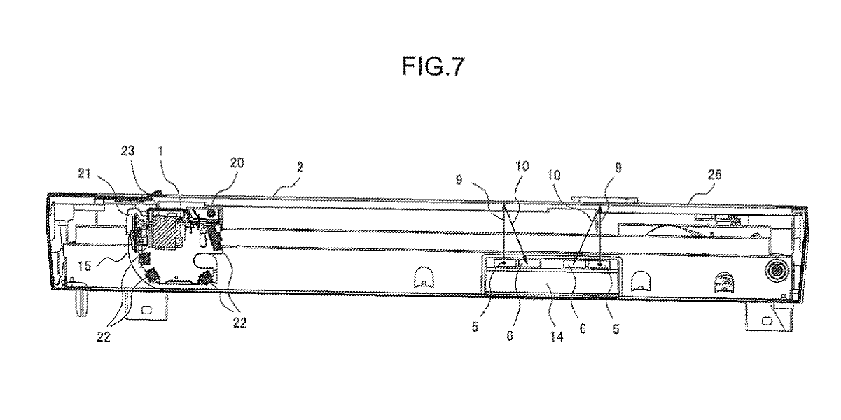

FIG. 7 is an explanatory diagram showing a cross section view taken along D-D line of the image reading apparatus shown in FIG. 1. The optical module 1 includes the lamp 20, CCD 21, the mirror 22 and the lens 23. In the case that the lamp 20 emits light to the manuscript 2 in order to read the image, the emission light reaches to the manuscript 2 which is placed on a manuscript platen 26 made of glass. Then, the light which irradiates the manuscript 2 is reflected repeatedly by several mirrors 22. Afterward, the reflection light is concentrated by the lens 23. Afterward, when the concentrated light comes in the pixel plane of CCD 21, CCD 21 converts the electric charge into the electric signal. In this way, the optical module 1 reads the image of the manuscript 2.

Moreover, the emission light 9, which is emitted by each light emitting unit 5, is reflected by the manuscript 2 respectively. The reflection light 10, which is reflected by the manuscript 2, is received by the light receiving unit 6 which composes the pair together with the light emitting unit 5. In this way, the size sensor 4 detects the size (length) of the manuscript.

According to the image reading apparatus of the exemplary embodiment, the optical module 1 slides inside the chassis 11, which is arranged below the manuscript platen, in parallel to the manuscript platen in the sub scanning direction (Y direction) and then, reads the image of the manuscript 2, as mentioned above. Moreover, the size sensor 4 has two pairs each of which is composed of the light emitting unit 5 and the light receiving unit 6.

The light emitting units 5 and the light receiving units 6 are arranged on one substrate 7 so that each line between the light emitting unit 5 and the light receiving unit 6, which composes the pair, may be on one straight line. Moreover, the size sensor 4 is arranged at one internal side area of the chassis 11, which does not overlap with the area through which the optical module 1 slides, so that the line connecting the light emitting unit 5 with the light receiving unit 6 may become parallel to the sub scanning direction.

By the structure mentioned above, it is possible to miniaturize the external form of the chassis of the image reading apparatus with the size sensor which detects the size of the manuscript.

That is, according to the image reading apparatus of the exemplary embodiment, the optical module 1 reads the image of the manuscript 2 in the sub scanning direction. For this reason, the size sensor 4 is mounted on the back side of the base plane of the chassis 11, to which the optical module 1 dose not slide, so that the optical module 1 may become parallel to the sub scanning direction which is exemplified in FIG. 1. Moreover, according to the image reading apparatus of the exemplary embodiment, as shown in FIG. 4, the size sensor 4 is arranged at an angle to the X-Y plane to save a space for mounting the size sensor 4. As a result, it is possible to prevent the size sensor 4 from being mounted in a form projecting downward out of the base plane of the chassis as shown in FIG. 7. For this reason, it is possible to make the base plane of the chassis 11 flat and furthermore, to make height and depth of the chassis 11 restricted. As a result, it is possible to provide an apparatus whose external form is miniaturized.

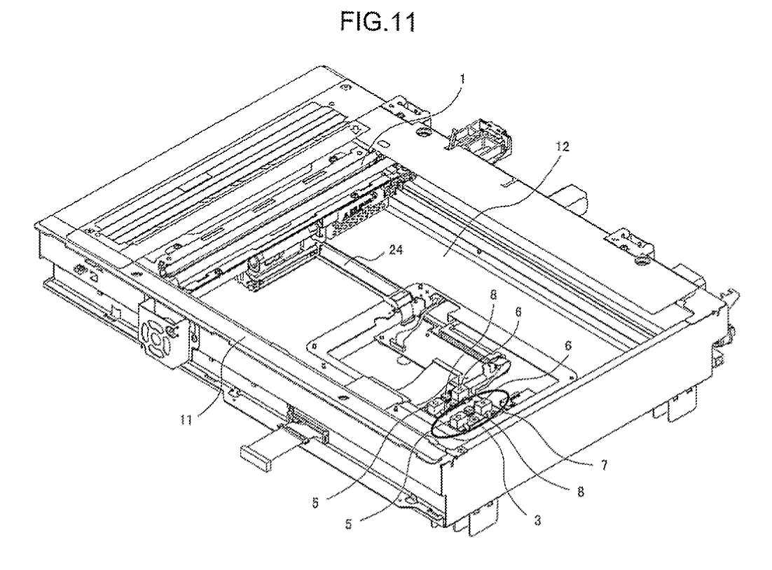

In the case of, for example, the general image reading apparatus, two size sensors 3 are arranged separately as shown in FIG. 11. For this reason, there is a problem that number of the components for fixing the size sensor 3, the assembly time for mounting the components, and cost of the components become increasing. In the case of judging the size of the manuscript 2 closely, it is necessary to increase number of the size sensor 3 and furthermore to mount the component for fixing the size sensor 3. For this reason, there is a problem that the apparatus becomes more expensive.

However, according to the exemplary embodiment, all of the light emitting units 5 and the light receiving unit 6 are arranged on the straight line on one substrate 7 as shown in FIG. 2 and the size sensor 4 is composed as one component. As a result, it is unnecessary to use the component for fixing the size sensor 4 and consequently, it is possible to reduce the assembly time and to lower the price of the apparatus.

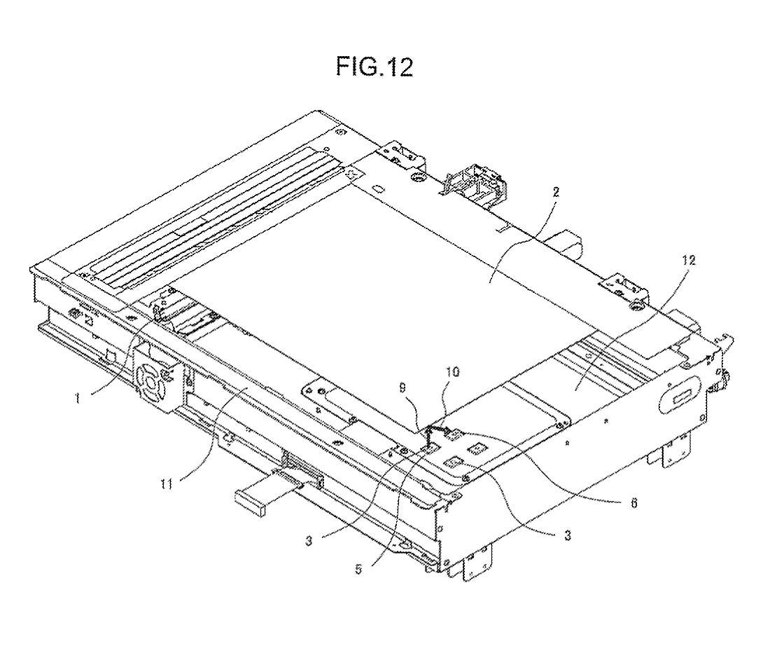

Moreover, in the case of, for example, the general image reading apparatus, the size sensor 3 is mounted upward as shown in FIG. 12. For this reason, in the case that the size sensor 3 receives external light which is emitted from a position over the image reading apparatus, such as light from a fluorescent lamp, the size sensor 3 may judges in many cases that the received light is the reflection light 10 which is reflected by the manuscript 2. As mentioned above, the size sensor 3 may not judge the size (length) of the manuscript 2 correctly in some cases.

However, according to the exemplary embodiment, the size sensor 4 is arranged so that the light axis of the emission light 9 which is emitted from the light emitting unit 5, and the light axis of the reflection light 10 which the light receiving unit 6 receives, may be at an angle to the plane Y-Z. Moreover, the size sensor 4 is not arranged in the area where the glass opening of the manuscript platen is projected vertically. By the structure, it is possible to prevent that the external light, which is emitted from a position over the apparatus, comes in the size sensor 4 directly. As a result, it is possible to improve precision which is required for detecting the size (length) of the manuscript 2.

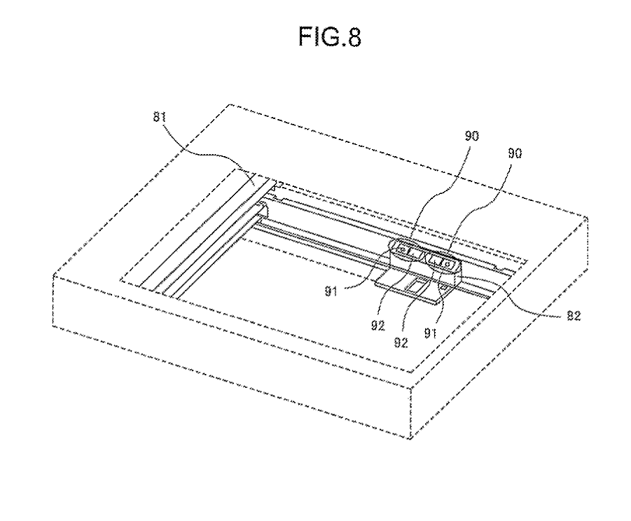

Next, an example of the minimum structure of a image reading apparatus according to the present invention will be described. FIG. 8 is an explanatory diagram showing the example of the minimum structure of the image reading apparatus according to the present invention. The image reading apparatus according to the present invention includes an image reader 81 and a size detector 82. The image reader 81 (for example, optical module 1) reads an image of a manuscript (for example, manuscript 2) which is placed on a manuscript platen. The size detector 82 (for example, size sensor 4) detects a size (for example, size or length) of the manuscript.

The image reader 81 slides inside a chassis (for example, chassis 11), which is arranged below the manuscript platen, in parallel to the manuscript platen (for example, in the Y direction in FIG. 1) and then, reads the image of the manuscript.

The size detector 82 includes two optical sensors 90 each of which is composed of a pair of the light emitter 91 and the light receiver 92 (for example, pair of light emitting unit 5 and light receiving unit 6). The light emitter 91 (for example, light emitting unit 5) emits light (for example, emission light 9) toward the manuscript platen from a position below the manuscript platen. The light receiver 92 (for example, light receiving unit 6) receives reflection light (for example, reflection light 10) which is reflected by the manuscript.

The light emitter 91 and the light receiver 92 are arranged on one substrate (for example, substrate 7) so that each line connecting the light emitter 91 with the light receiver 92 may be on one straight line.

Moreover, the size detector 82 is arranged in one internal side area of the chassis, which does not overlap with an area through which the optical module 1 slides, so that the line connecting the light emitter 91 with the light receiver 92 may become parallel to a sliding direction of the image reader 81 (for example, sub scanning direction).

By the structure, it is possible to miniaturize an external form of the chassis of the image reading apparatus with a size sensor which detects the size of a manuscript.

Moreover, it may be preferable that out of two light sensor 90, the light emitter 91 and the light receiver 92, which belong to one light sensor 90 near to a manuscript reading starting position where the image reader 81 starts to read the manuscript, are arranged in such an order that the light emitter 91 is nearer to the manuscript reading starting position than the light receiver 92. On the other hand, it may be preferable that the light emitter 91 and the light receiver 92, which belong to the other light sensor 90, are arranged in such an order that the light receiver 92 is nearer to the manuscript reading starting position than the light emitter 91 (refer to FIG. 2).

Moreover, it may be preferable that the size detector 82 is arranged obliquely so that an axis of light, which is emitted by the light emitter 91, is at a predetermined angle (for example, angle θ) with the vertical direction. As a result, it is possible that the size detector 82 judges whether the manuscript is placed on the manuscript platen, even if the size detector 82 is not arranged on a base plane.

Moreover, it may be preferable that the size detector 82 is arranged at a position which does not overlap with an area to which a glass opening of the manuscript platen is projected vertically. By the structure, it is possible to improve precision which is required for detecting the size (length) of the manuscript 2.

Moreover, it may be preferable that the size detector 82 is arranged between rails (for example, rails 17) which are arranged at both ends of the main scanning direction inside the chassis in order to draw the image reader 81. By the structure, it is possible to make the size of the chassis in the depth direction small. As a result, it is possible to miniaturize the apparatus.

Moreover, it may be preferable that the base plane is in an almost flat form.

Moreover, it may be preferable that the image reading apparatus includes a sensor holder (for example, sensor holding unit 14) which fixes the size detector to one internal side area of the chassis. Moreover, it may be preferable that the sensor holder fixes a flat cable (for example, FFC15), which connects the image reader 81 and the size detector 82 each other, to the base plane of the chassis. By the structure, it is possible to reduce number of components which are used in the image reading apparatus.

While a part of or a whole of the exemplary embodiment mentioned above will be able to be described like the following addition, the exemplary embodiment is not limited to the addition mentioned later.

(Addition 1) An image reading apparatus, comprising:

an image reader to read an image of a manuscript which is placed on a manuscript platen; and

a size detector to detect a size of the manuscript, wherein

the image reader slides inside a chassis, which is arranged below the manuscript platen, in parallel to the manuscript platen and reads the image of the manuscript, wherein

the size detector includes two light sensors each of which is composed of a pair of a light emitter to emit light toward the manuscript platen from a position under the manuscript platen, and a light receiver to receive reflection light which is reflected by the manuscript, wherein

the light emitter and the light receiver are mounted on one substrate so that each line connecting the light emitter with the light receiver of the light sensor may be on one straight line, and wherein

the size detector is arranged at one internal side area of the chassis, which does not overlap with an area to which the image reader slides, so that the line connecting the light emitter with the light receiver may be parallel to a sliding direction of the image reader.

(Addition 2) The image reading apparatus according to the addition 1, wherein

out of two light sensors, the light emitter and the light receiver, which belong to one light sensor near to a manuscript reading starting position where the image reader starts to read the manuscript, are arranged in such an order that the light emitter is nearer to the manuscript reading starting position than the light receiver, and wherein

the light emitter and the light receiver, which belong to the other light sensor, are arranged in such an order that the light receiver is nearer to the manuscript reading starting position than the light emitter.

(Addition 3) The image reading apparatus according to the addition 1, wherein

the size detector is arranged obliquely so that an axis of light, which is emitted by the light emitter, is at an angle with the vertical direction.

(Addition 4) The image reading apparatus according to the addition 1, wherein

the size detector is arranged at a position within the chassis which does not overlap with an area to which a glass opening of the manuscript platen is projected vertically.

(Addition 5) The image reading apparatus according to the addition 1, wherein

the size detector is arranged between rails which are arranged at both ends of the main scanning direction inside the chassis in order to draw the image reader.

(Addition 6) The image reading apparatus according to the addition 1, wherein

a base plane is in an almost flat form.

(Addition 7) The image reading apparatus according to the addition 1, comprising:

a sensor holder which fixes the size detector to one internal side end of the chassis, wherein

the sensor holder fixes a flat cable, which connects the image reader and the size detector each other, to a base plane of the chassis.

(Addition 8) An image reading apparatus, comprising:

image reading means for reading an image of a manuscript which is placed on a manuscript platen; and

size detecting means for detecting a size of the manuscript, wherein

the image reading means slides inside a chassis, which is arranged below the manuscript platen, in parallel to the manuscript platen and reads the image of the manuscript, wherein

the size detecting means includes two light sensors each of which is composed of a pair of light emitting means for emitting light toward the manuscript platen from a position under the manuscript platen, and light receiving means for receiving reflection light which is reflected by the manuscript, wherein

the light emitting means and the light receiving means are mounted on one substrate so that each line connecting the light emitting means with the light receiving means of the light sensor may be on one straight line, and wherein

the size detecting means is arranged at one internal side area of the chassis, where does not overlap with an area through which the image reading means slides, so that the line connecting the light emitting means with the light receiving means may be parallel to a sliding direction of the image reading means.

According to the manuscript reading apparatus which is disclosed in the patent document 1, the manuscript detecting sensor is mounted in the form projecting in the direction toward the center of the base plane. Therefore, it is necessary to make the sliding position of the optical unit high so that the manuscript detecting sensor may not disturb the optical unit's sliding. Accordingly, there is a problem that the external form becomes large as the position of the optical unit is made high.

According to the present invention, the external form of the chassis of the image reading apparatus, which includes the size sensor to detect the size of the manuscript, can be made miniaturized.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. An image reading apparatus, comprising:
image reader reading an image of a manuscript which is placed on a manuscript platen; and
size detector detecting a size of the manuscript, wherein
the image reader slides inside a chassis, which is arranged below the manuscript platen, in parallel to the manuscript platen and reads the image of the manuscript, wherein
the size detector includes two light sensors each of which is composed of a pair of light emitter emitting light toward the manuscript platen from a position under the manuscript platen, and light receiver receiving reflection light which is reflected by the manuscript, wherein
the light emitter and the light receiver are mounted on one substrate so that each line connecting the light emitter with the light receiver of the light sensor may be on one straight line, and wherein
the size detector is arranged at one internal side area of the chassis, which does not overlap with an area through which the image reader slides, so that the line connecting the light emitter with the light receiver may be parallel to a sliding direction of the image reader.

2. The image reading apparatus according to claim 1, wherein
out of two light sensors, the light emitter and the light receiver, which belong to one light sensor near to a manuscript reading starting position where the image reader starts to read the manuscript, are arranged in such an order that the light emitter is nearer to the manuscript reading starting position than the light receiver, and wherein
the light emitter and the light receiver, which belong to the other light sensor, are arranged in such an order that the light receiver is nearer to the manuscript reading starting position than the light emitter.

3. The image reading apparatus according to claim 1, wherein
the size detector is arranged obliquely so that an axis of light, which is emitted by the light emitter, is at an angle with the vertical direction.

4. The image reading apparatus according to claim 1, wherein
the size detector is arranged at a position within the chassis which does not overlap with an area to which a glass opening of the manuscript platen is projected vertically.

5. The image reading apparatus according to claim 1, wherein
the size detector is arranged between rails which are arranged at both ends of the main scanning direction inside the chassis in order to draw the image reader.

6. The image reading apparatus according to claim 1, wherein
a base plane of the chassis is in a almost flat form.

7. The image reading apparatus according to claim 1, further comprising:
a sensor holder fixing the size detecting means to one internal side end of the chassis, wherein
the sensor holder fixes a flat cable, which connects the image reader and the size detector, to a base plane of the chassis.

8. An image reading apparatus, comprising:
image reading means for reading an image of a manuscript which is placed on a manuscript platen; and
size detecting means for detecting a size of the manuscript, wherein
the image reading means slides inside a chassis, which is arranged below the manuscript platen, in parallel to the manuscript platen and reads the image of the manuscript, wherein
the size detecting means includes two light sensors each of which is composed of a pair of light emitting means for emitting light toward the manuscript platen from a position under the manuscript platen, and light receiving means for receiving reflection light which is reflected by the manuscript, wherein
the light emitting means and the light receiving means are mounted on one substrate so that each line connecting the light emitting means with the light receiving means of the light sensor may be on one straight line, and wherein
the size detecting means is arranged at one internal side end of the chassis, which does not overlap with an area through which the image reading means slides, so that the line connecting the light emitting means with the light receiving means may be parallel to a sliding direction of the image reading means.
